(19) United States
(12) Patent Application Publication
(10) Pub. No.: US 2012/0134019 A1
(43) Pub. Date: May 31, 2012

(54) THREE DIMENSION DISPLAY DEVICE

(75) Inventor: Yanbing WU, Beijing (CN)

(73) Assignee: BOE TECHNOLOGY GROUP CO., LTD., Beijing (CN)

(21) Appl. No.: 13/305,055

(22) Filed: Nov. 28, 2011

(30) Foreign Application Priority Data
Nov. 26, 2010 (CN) 201010569108.4

(51) Int. Cl. G02B 27/26

(52) U.S. Cl. 359/463

(57) ABSTRACT

An embodiment of the disclosed technology provides a three dimension display device comprising a polarized light modulator and a display unit comprising a lighting display array and a transparent substrate, wherein a lens array comprises multiple converging lenses is further provided between the lighting display array and the polarized light modulator, each left eye image pixel and each right eye image pixel in the lighting display array are respectively aligned with at least one of the converging lenses.

### BACKGROUND

Embodiments of the disclosed technology relate to a three dimension display device.

As shown in FIG. 1, an existing three dimension (3D) display device comprises a display unit 10, a polarizing film 20 and a polarized light modulator 30. A portion of the pixels of the display unit 10 are used for displaying left eye images (the shadow region of left-ward slanting lines), and the other pixels are used for displaying right eye images (see the shadow part of right-ward slanting lines). After passing through the polarizing film 20, light for these images becomes polarized light with a single polarization direction, for example, with the polarization direction in parallel with the paper surface (see the two parallel lines) in FIG. 1. In particular, the polarized light modulator 30 may be a phase difference plate or a liquid crystal cell (e.g., the polarized light modulator 30 is a liquid crystal cell in FIG. 1) which adjusts the polarization direction of the polarized light by delaying the phase or twisting the liquid crystal molecules. As shown in FIG. 1, all the polarized light emitted from the polarizing film 20 runs in parallel with the paper surface; then the polarization direction of the polarized light are adjusted by the polarized light modulator 30, and as a result, the polarization direction of the polarized light for the left eye image is rotated to the direction perpendicular to the paper surface (shown as the double round spots), while the polarization direction of the polarized light for the right eye image still runs in parallel with the paper surface. FIG. 2 is a schematic view showing the variation of the polarization directions in the three dimension display. The viewer can reestablish a third dimension image by wearing a eyeglass 40 which makes the left eye only receive the left eye image and the right eye only receive the right eye image.

There are at least the following disadvantages for the exiting three dimension display device:

As shown in FIG. 3, the display unit 10 inevitably comprises a transparent substrate 12 with a certain thickness besides a lighting display array 11. There is a certain distance between the polarized light modulator 30 and the lighting display array 11 due to the existence of the transparent substrate 12 and the polarizing film 20 provided thereon. Therefore, crosstalk between the left eye image and the right eye image occurs. In other words, the viewer's right eye will receive the left eye image and the left eye will also receive the right eye image.

For example, as shown in FIG. 4A, when the viewer faces the polarized light modulator 30 in a forward direction, all the display pixels of the display unit and the counterparts in the polarized light modulator 30 are in a one-to-one correspondence relationship, which makes the viewer can see a third dimension image. As shown in FIG. 4B, when the viewer raises his or her position, the polarized light for the left eye image will pass through the regions of the polarized light modulator 30 which would have corresponded to the polarized light for the right eye image and arrives at the viewer's right eye (see the broken lines). Thus, crosstalk between the left eye image and the right eye image occurs.

### SUMMARY

An embodiment of the disclosed technology provides a three dimension display device comprising a polarized light modulator and a display unit comprising a lighting display array and a transparent substrate, wherein a lens array comprises multiple converging lenses is further provided between the lighting display array and the polarized light modulator, each left eye image pixel and each right eye image pixel in the lighting display array are respectively aligned with at least one of the converging lenses.

Further scope of applicability of the disclosed technology will become apparent from the detailed description given hereinafter. However, it should be understood that the detailed description and specific examples, while indicating preferred embodiments of the disclosed technology, are given by way of illustration only, since various changes and modifications within the spirit and scope of the disclosed technology will become apparent to those skilled in the art from the following detailed description.

### BRIEF DESCRIPTION OF THE DRAWINGS

The disclosed technology will become more fully understood from the detailed description given hereinafter and the accompanying drawings which are given by way of illustration only, and thus are not limitative of the disclosed technology and wherein:

FIG. 1 is a structural schematic view of an existing three dimension display device;

FIG. 2 is a schematic view showing the variation of the polarization directions of the light in the existing three dimension display;

FIG. 3 is a schematic view showing the structure of the display unit 10 in FIG. 1;

FIG. 4A and FIG. 4B is a schematic view showing how the crosstalk occurs in the existing three dimension display device;

FIG. 5A to FIG. 5C are schematic views showing optional positions of the lens array in the three dimension display device according to embodiments of the disclosed technology;

FIG. 6 is a schematic view showing an optional structure of the three dimension display device according to the embodiments of the disclosed technology in which the convex lenses is used as the converging lenses; and

FIG. 7 is a schematic view showing an exemplary structure of the three dimension display device according to the embodiments of the disclosed technology in which the triple prisms is used as the converging lenses.

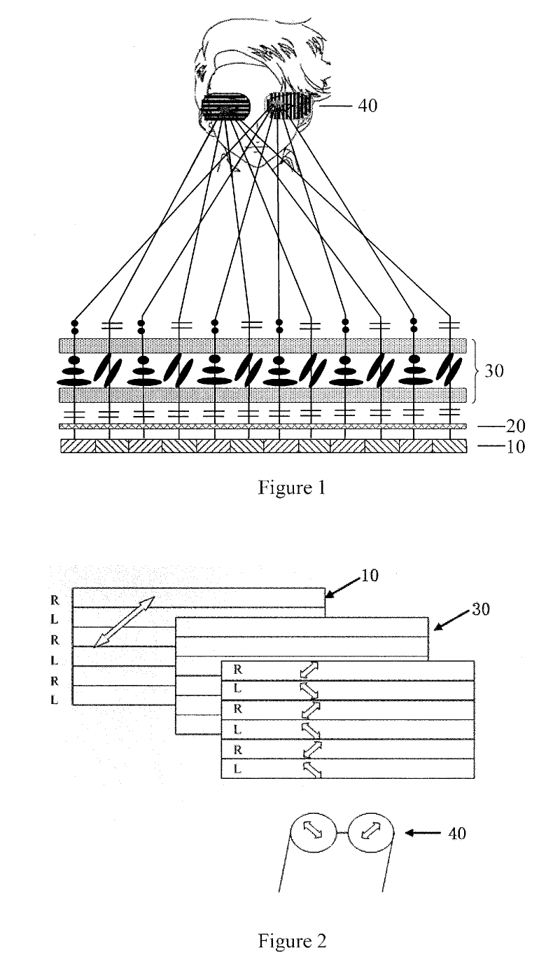

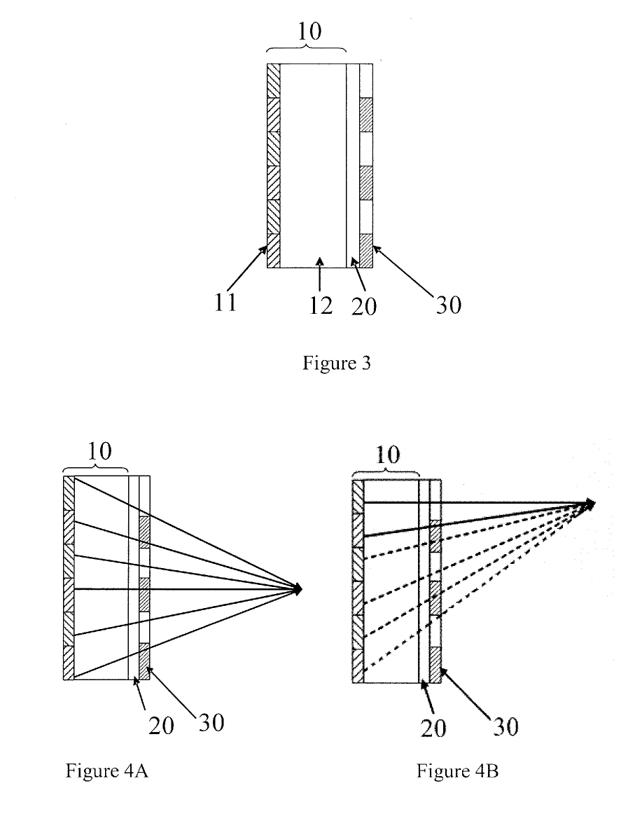

### DETAILED DESCRIPTION

Hereinafter, embodiments will be described in detail with reference to the accompanying drawings so that the objects, technical solutions and advantages of the embodiments will become more apparent. It should be noted that the embodiments described below are merely a portion of but not all of the embodiments of the disclosed technology, and thus various modifications, combinations or alterations can be made on the basis of the described embodiments without departing from the spirit and scope of the disclosed technology.

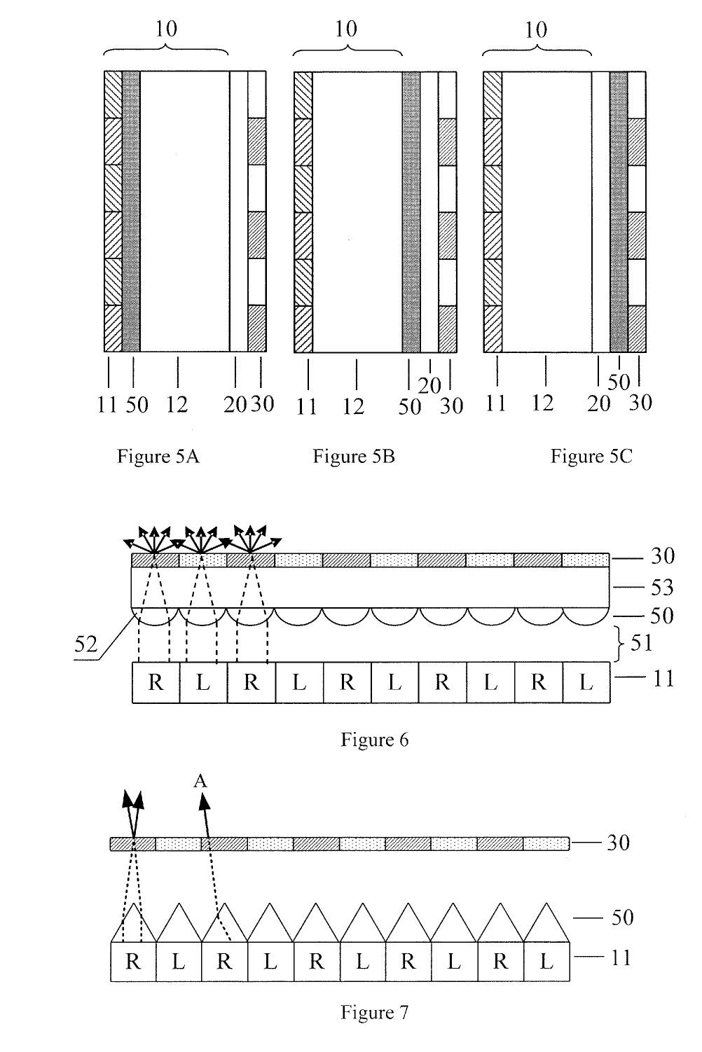

As shown in FIG. 5A to FIG. 5C, the three dimension display device in an embodiment comprises a display unit 10 and a polarized light modulator 30. The display unit 10 comprises a lighting display array 11 and a transparent substrate 12, and this transparent substrate 12 may be provided between the lighting display array 11 and the polarized light modulator 30. A lens array 50 is further inserted between the lighting display array 11 and the polarized light modulator 30 at one of various possible locations.

As shown in FIG. 5A, the lens array 50 is provided between the lighting display array 11 and the transparent substrate 12. A polarizing film 20 can further provided between the display unit 10 and the polarized light modulator 30, and in this case the lens array 50 can also be located between the transparent substrate 12 and the polarizing film 20 or between the polarizing film 20 and the polarized light modulator 30.

The lens array 50 may comprises multiple converging lenses. Each of the left eye image pixel and the right eye image pixel in the lighting display array 11 is respectively aligned with at least one of the converging lenses. The left eye image pixels are the pixels which are used to display a left eye image in the lighting display array 11; the right eye image pixels are the pixels which are used to display a corresponding right eye image in the lighting display array 11. Each of the left eye image pixels and the right eye image pixels can comprise one or more actual pixels. Preferably, each left eye image pixel and each right eye image pixel are respectively aligned with the converging lenses as more as possible; therefore, small-scale converging lenses can be used so that concavo-convex surface (texture) of the converging lenses becomes inconspicuous. In addition, the converging lens has various optional structures, for example as follows.

It is understood that it is necessary to assure that the convex lens 52 in the lens array 50 is located between the lighting display array 11 and the polarized light modulator 30 in the three dimension display device of the embodiment. Therefore, to simplify description, the transparent substrate 12 and the polarizing film 20 are omitted from the following FIG. 6 and FIG. 7.

As shown in FIG. 6, each converging lens in the lens array 50 is a convex lens 52; the letter “L” represents the left eye image pixels in the lighting display array 11 in FIG. 6, and the letter “R” represents the right eye image pixels correspondingly. Each left eye image pixel and each right eye image pixel are respectively aligned with one convex lens 52; the shadow regions of slanting lines in the polarized light modulator 30 represent the parts in polarized light modulator 30 which correspond to the polarized light for a right eye image, and the shadow regions of round spots represent the parts in the polarized light modulator 30 which correspond to the polarized light for a left eye image corresponding to the right eye image.

Alternatively, in order to adjust the relative distances among the polarized light modulator 30, the lens array 50 and the lighting display array 11, a transparent distance adjusting substrate 53 may further be provided between the lens array 50 and the polarized light modulator 30. The thickness of the distance adjusting substrate 53 makes the polarized light modulator 30 located at the image points (image distance) of the convex lenses 52; and, there may be a space 51 between the lens array 50 and the lighting display array 11 such that the lighting display array 11 is located at the object points (object distance) of the convex lenses 52. As a result, an image with the same size as the image displayed by the lighting display array 11 can be shown on the polarized light modulator 30 to improve the display quality. In addition, during the production process, the space 51 can be filled with a transparent resin in order to assure its stability.

In the embodiment, since the lens array 50 is provided in the three dimension display device, light emitted from each pixel of the lighting display array 11 converges onto the corresponding region of the lower surface of the polarized light modulator 30 with the converging effect of the converging lens, which equals to the fact that the lighting display array 11 is elevated to the location right below the polarized light modulator 30, in other words, the distance between the lighting display array 11 and the polarized light modulator 30 becomes almost equal to zero. As a result, the crosstalk due to the observation angle will not occur and the observation angle of three dimension display is enlarged.

In addition, as shown in FIG. 7, each converging lens in the lens array 50 may be a triangular prism, which makes the light emitted from each of the pixels of the lighting display array 11 converges due to the refraction action of the triangular prism. For example, light ray A comes from a right eye image pixel in FIG. 7. The light ray A may pass through and exit from the region corresponding to a left eye image pixel in the polarized light modulator 30 without the triangular prism; in contrast, light ray A can accurately pass through and exit from the region corresponding to the right eye image pixel in the polarized light modulator 30 with the aid of the triangular prism. Thus, the crosstalk between the left eye image and the right eye image can be suppressed or eliminated.

The disclosed technology being thus described, it will be obvious that the same may be varied in many ways. Such variations are not to be regarded as a departure from the spirit and scope of the disclosed technology, and all such modifications as would be obvious to those skilled in the art are intended to be comprised within the scope of the following claims.

What is claimed is:

1. A three dimension display device comprising:
a polarized light modulator, and
a display unit comprising a lighting display array and a transparent substrate,
wherein a lens array comprises multiple converging lenses is further provided between the lighting display array and the polarized light modulator, and each left eye image pixel and each right eye image pixel in the lighting display array are respectively aligned with at least one of the converging lenses.

2. The three dimension display device according to claim 1, wherein the converging lenses are triangular prisms.

3. The three dimension display device according to claim 1, wherein the converging lenses are convex lenses.

4. The three dimension display device according to claim 3, wherein a transparent distance adjusting substrate is further provided between the lens array and the polarized light modulator, and
the distance adjusting substrate has a thickness which makes the polarized light modulator locate at the image points of the converging lenses.

5. The three dimension display device according to claim 3, wherein a space is provided between the lens array and the lighting display array such that the lighting display array locates at the object points of the converging lenses.

6. The three dimension display device according to claim 5, wherein the space is filled with a transparent resin.

7. The three dimension display device according to claim 1, wherein a polarizing film is further provided between the lighting display array and the polarized light modulator, and
the lens array is located between the lighting display array and the transparent substrate, between the transparent substrate and the polarizing film, or between the polarizing film and the polarized light modulator.
